(19) United States
(12) Patent Application Publication
(10) Pub. No.: US 2025/0037598 A1
(43) Pub. Date: Jan. 30, 2025

(54) SYSTEM FOR TRAINING LEARNING SKILLS AND HABITS BASED ON ARTIFICIAL INTELLIGENCE USING QUESTION GENERATION, METHOD THEREOF, AND STORAGE MEDIUM HAVING THE SAME

(71) Applicant: Kyeong Hee JEON, Seongnam-si (KR)

(72) Inventor: Kyeong Hee JEON, Seongnam-si (KR)

(21) Appl. No.: 18/811,877

(22) Filed: Aug. 22, 2024

Related U.S. Application Data
(63) Continuation-in-part of application No. PCT/KR2023/003152, filed on Mar. 8, 2023.

(30) Foreign Application Priority Data
Mar. 8, 2022 (KR) 10-2022-0029295
Jun. 30, 2022 (KR) 10-2022-0080342

(51) Int. Cl. G09B 7/04

(52) U.S. Cl. CPC G09B 7/04

(57) ABSTRACT

A system for training learning skills and habits based on artificial intelligence. The system includes: a learner terminal in which an application for providing an AI-based learning skill and habit training service through question generation is installed, that receives a desired question topic selected from the learner among at least one preset question topic, and receives question information corresponding to the selected question topic from the learner; and a training server which provides the AI-based learning skill and habit training service through question generation, sets the at least one question topic to be transmitted to the learner terminal and a learning step of each question topic, generates a learning result through machine learning-based analysis of the received question information from the learner terminal, and transmits a next learning content recommended for the learner to the learner terminal based on the learning result obtained through the machine learning.

### TECHNICAL FIELD

Embodiments relate to a system and method for learning skill and habit training based on artificial intelligence (AI) through question generation. More particularly, embodiments relate to a system and method using a question generation step associated with each learning step before, during and after class, wherein the question generation step uses an online (web, app, AI) program to allow a learner to select a given assignment and topic, and a questioner to generate a question and input the question according to a program system to complete a thinking training process, thereby performing the learning steps in a naturally connected manner according to the order of question generation before during and after class.

### BACKGROUND ART

When learners exhibit low performance (academic achievement falls below the target level) despite long-term efforts, the learners get stressed while studying. Additionally, teaching young (so-call best age for learning) students by rote does not lead to creative, critical and logical thinking and humanistic education, and fails to help the student to gain skills needed in the era of the fourth industrial revolution and to provide a balanced education.

Accordingly, it is necessary to train learners to develop proper learning skill and habit to encourage them to enjoy learning without learning burden, and naturally incorporate creativity and humanistic skill training in the learning skill training process, to help students to develop their abilities to lead their lives by making choices through self-determination and decision making with the development and change of society, culture and technology.

Recently, educational underachievement resulting from reduced face-to-face learning during COVID-19 is of concern. To dispel the concern, there is a need for technology for meeting learners' needs through collaboration and various content to recover learning loss via online channels in the non-contact consumption trend after the COVID-19 pandemic through education combined with technology, so-called Edu-Tech, in reduced face-to-face learning situation.

Meanwhile, the above-described background art is technology information possessed by the inventors to devise the present disclosure, or acquired in the process of devising the present disclosure, and is not a known technology available to the public before the filing date of the present disclosure.

### SUMMARY

### Technical Problem

According to an aspect of the present disclosure, there are provided a system and method for learning skill and habit training based on artificial intelligence (AI) through question generation, to train a learner to develop a proper learning skill and habit to encourage the learner to enjoy learning without learning burden, and naturally incorporate creativity and humanistic skill training in the learning skill training process through question generation, to help students to develop their ability to make determination and decisions by themselves with the development and change of society, culture and technology, and a computer program therefor.

### Technical Solution

An artificial intelligence (AI)-based learning skill and habit training system through question generation according to an embodiment of the present disclosure includes a learner terminal that is a personal terminal that a learner uses, and in which a dedicated application for providing an AI-based learning skill and habit training service through question generation is installed, the learner terminal configured to receive a desired question topic selected from the learner among at least one preset question topic, and receive question information corresponding to the selected question topic from the learner; and a training server configured to provide the AI-based learning skill and habit training service through question generation, set the at least one question topic to be transmitted to the learner terminal and a learning step of each question topic, generate a learning result through machine learning-based analysis of the received question information from the learner terminal, and transmit a next learning content recommended for the learner to the learner terminal based on the learning result obtained through the machine learning.

A training server for providing an AI-based learning skill and habit training service through question generation according to an embodiment of the present disclosure includes a memory in which executable instructions are stored; a communication module configured to communicate with a server; and a processor connected to the memory and the communication module to enable communication between them.

The processor is configured to execute the instructions to perform the steps of: setting at least one question topic to be transmitted to a learner terminal that is a personal terminal of a learner and a learning step of each question topic; receiving question information corresponding to a desired question topic selected from the learner on the learner terminal from the learner in response to the question topic being selected from the learner through the learner terminal among the at least one question topic transmitted to the learner terminal; generating a learning result through machine learning-based analysis of the received question information from the learner terminal; and transmitting a next learning content recommended for the learner to the learner terminal based on the learning result obtained through the machine learning.

In an embodiment, the AI-based learning skill and habit training system through question generation according to another embodiment of the present disclosure may further include a supplementary learning terminal formed in a shape of a helmet that is worn on a head of the learner, and connecting to the learner terminal to receive the question topic transmitted to the learner terminal from the learner terminal, output the question topic in a form of a sound or letter, receive a voice input from the learner and transmit it to the learner terminal; a first learning attitude correction terminal mounted on a left shoulder part of the learner, and connecting to the learner terminal to vibrate to teach the learner in a bad posture for learning during question generation training to sit in a good posture for learning; and a second learning attitude correction terminal mounted on a right shoulder part of the learner, and connecting to the learner terminal to vibrate to teach the learner in a bad posture for learning during question generation training to sit in a good posture for learning.

In an embodiment, the first learning attitude correction terminal may include a holder frame curved in an arch shape to conform to a shape of the shoulder so that the holder frame is placed on the left shoulder part of the learner; a gyro sensor installed at the holder frame and configured to measure a position change of the left shoulder of the learner and transmit it to the learner terminal; a mounting frame curved in an arch shape to conform to the shape of the shoulder so that the mounting frame is closely mounted on the left shoulder of the learner and installed on an inner side of the holder frame facing the shoulder; a frame vibrator configured to slidably move on a curve along the inner side of the holder frame under the control of the learner terminal, and after stopping the sliding movement at a specific location, rotate to tap the mounting frame, to provide a vibration for warning to the learner; and a drive belt installed along the inner side of the holder frame and engaged with the frame vibrator, and configured to slidably move the frame vibrator on the curve along the inner side of the holder frame by forward or backward rotation under the control of the learner terminal.

In an embodiment, the holder frame may include an arch-shaped frame curved in an arch shape to conform to the shape of the shoulder so that the arch-shaped frame is placed on the left shoulder part of the learner, to form an open internal space to form an open portion on a lower side facing the shoulder; two frame holder steps bent in a horizontal direction such that one side and the other of a lower part of the arch-shaped frame faces each other to fasten one side and the other side of the mounting frame; a gear mounting step formed along one side wall of the internal space of the arch-shaped frame so that the frame vibrator is mounted and allowed to move while rotating, and forming gear teeth along an upper side so that the frame vibrator is installed and connected and engaged with the gear teeth; a spring support step disposed opposite the gear mounting step and protruding along the other side wall of the internal space of the arch-shaped frame; a belt mounting space extended in a front-rear direction along an inner side of the arch-shaped frame, facing the internal space of the arch-shaped frame, spaced apart in an upward direction from the internal space of the arch-shaped frame so that an upper side of the drive belt is mounted and allowed to move; two belt support steps protruding in the horizontal direction such that they face each other from the top of one side wall and the other side wall of the internal space of the arch-shaped frame to support one side and the other side of the lower part of the drive belt mounted on the upper surface of the internal space of the arch-shaped frame; a first support spring including a plurality of first support springs arranged at a regular interval along a lower side of the gear mounting step to bring one side of the upper part of the mounting frame mounted on the frame holder step formed on one side into close contact in a downward direction; and a second support spring including a plurality of second support springs arranged at a regular interval along the lower side of the spring support step to bring the other side of the upper part of the mounting frame mounted on the frame holder step formed on the other side into close contact in the downward direction.

In an embodiment, the frame vibrator may include a sliding gear with an upper side installed and connected and engaged with gear teeth formed along a outer surface of a lower side of the drive belt and a lower side installed and connected and engaged with gear teeth formed along an upper side of the gear mounting step, and configured to move back and forth while rotating along the upper side of the gear mounting step by rotation with the forward or backward rotation of the drive belt; a rotary motor installed on an inner side of the sliding gear and rotating under the control of the learner terminal; and a tapping unit installed at a drive axis of the rotary motor exposed from the sliding gear perpendicularly to a rotation axis of the sliding gear, and configured to tap the mounting frame by rotation with the rotation of the drive axis of the rotary motor.

In an embodiment, the tapping unit may include a housing installed at the drive axis of the rotary motor perpendicularly to the rotation axis of the sliding gear; a vertical movement frame mounted in an internal space of the housing with an upper side exposed to an upper side of the housing; a frame support spring installed in the internal space of the housing, wherein the vertical movement frame is disposed along an inner side and a lower side is mounted on a step formed along the lower side of the vertical movement frame to bring the vertical movement frame into close contact with the lower side of the housing; and a tapping rubber ball with an upper side installed on the upper side of the vertical movement frame exposed to the upper side of the housing and configured to tap the mounting frame.

An AI-based learning skill and habit training method through question generation according to an embodiment of the present disclosure may include a question generation step of setting, by a training server for providing an AI-based learning skill and habit training service through question generation, at least one question topic to be transmitted to a learner terminal that is a personal terminal of a learner and a learning step of each question topic; a question information input step of receiving question information corresponding to a desired question topic selected from the learner on the learner terminal from the learner and transmitting it to the training server, in response to the question topic being selected from the learner through the learner terminal among the at least one question topic transmitted from the training server to the learner terminal; an AI analysis step of generating, by the training server, a learning result through machine learning-based analysis of the question information received from the learner terminal; and a learning recommendation step of transmitting, by the training server, a next learning content recommended for the learner to the learner terminal based on the learning result obtained through the machine learning.

In an embodiment, the question information input step may include receiving the question information corresponding to any one type of “when an answer is clearly found in a text”, “when an answer is absent in the text but can be found through immediate thinking” and “when an answer is absent in the text but can be found by inference through deep thinking and experience” from the learner.

In an embodiment, the question information input step may include instructing the learner to select and input the learning step related to the question topic among the learning steps of “before class”, “during class”, and “after class” when the learner selects the corresponding question topic, and the learner may be allowed to change a type of the question topic to be inputted by the learner for each step of “before class”, “during class”, and “after class”.

In an embodiment, the AI analysis step may include extracting at least one information of “number of input questions”, “time taken to input the question”, “a size of the question information (i.e., a length of the question)”, and “multidimensional information including features of words included in the question” as input data from data of the question information received from the learner terminal, and classifying the question information using the extracted input data as input value of a machine learning-based analysis model.

In an embodiment, the “features of the words included in the question” may refer to a result of classifying the words in the question into words about specific and basic representation or words about abstract and advanced interpretation,

In an embodiment, the AI analysis step may include, for word feature analysis, converting the question information to vector data by word embedding that represents a word having similar meaning as a similar vector value by using distributed representation from the question information inputted by the learner to classify the type of the word, and generating the learning result based on a result of classifying the question information.

In an embodiment, the AI analysis step may include applying an appropriate analysis model for each question information inputted by the learner in the multidimensional information for the machine learning analysis to classify the learning result according to a level of each learner.

In an embodiment, the next learning content may be a question topic that comes next in association with the question topic in the next class (i.e., the question that has been generated and inputted), or a question topic determined to need more question generation training among each step (i.e., before class, during class, and after class) of the question topic in the previous class.

In an embodiment, the learning recommendation step may include receiving feedback from a teacher, parent or manager as to whether the question information inputted by the learner is right for the required type of question in the corresponding learning step, and recommending the next learning content by leveling down the question topic in learning content recommended through machine learning by the AI analysis step or the learning step in each topic, in response to the feedback saying that the question is not a right question for the type being received at a predetermined ratio or more.

In an embodiment, the AI-based learning skill and habit training method through question generation according to another embodiment of the present disclosure may further include a posture correction step of teaching the learner in a bad posture for learning during question generation training to sit in a good posture for learning by vibration of a first learning attitude correction terminal and a second learning attitude correction terminal at a same time or at different times by using the first learning attitude correction terminal mounted on a left shoulder part of the learner and the second learning attitude correction terminal mounted on a right shoulder part of the learner.

The AI-based learning skill and habit training system through question generation according to an aspect of the present disclosure is configured to receive the question information generated by the learner for each preset step according to at least one topic, and generate the learning result of the learner through AI-based analysis of the question information.

The AI-based learning skill and habit training method through question generation according to an aspect of the present disclosure is configured to create a program for question generation together with the learning steps before class, during class and after class, so as to perform the learning steps in a connected manner according to an order of before class, during class and after class by using the question of each step.

A computer program according to an aspect of the present disclosure may be stored in a computer-readable recording medium to perform the above-described AI-based learning skill and habit training method through question generation in combination with hardware.

### Advantageous Effects

By the system and method for learning skill and habit training based on Artificial Intelligence (AI) through question generation according to an aspect of the present disclosure as described above, it may be possible to achieve cognitive learning training for developing learning skills by training the learners' concentration, memorization, understanding and thinking skills through the learning skill and habit training program based on AI such as machine learning and big data.

The system and method for learning skill and habit training based on AI through question generation generates learning results as to whether learners' input question information is a proper question based on AI technology, and allows the learners to select the next learning content based on the learning results, to train the learners' learning skill and habit through question generation. Through this, the learners can raise creativity and critical and logical thinking, and accordingly the system and method for learning skill and habit training based on AI through question generation according to the present disclosure provides learning skill and habit training technology that meets the needs of the present.

Additionally, the system and method for learning skill and habit training based on AI through question generation according to an aspect of the present disclosure performs the learning process before, during and after class by carrying out learning skill and habit training using textbooks as teaching materials, to help students to effectively study and make them interested in regular classes, thereby improve student achievement.

Additionally, the system and method for learning skill and habit training based on AI through question generation according to an aspect of the present disclosure may induce behavior modification through students' self-reflection by humanistic education in conjunction with emotional training (emotion reflection) and linguistic training (gratitude training), thereby improving the students' abilities to lead their lives.

### BRIEF DESCRIPTION OF DRAWINGS

FIG. 1 is a diagram showing an example of an operating environment of a system according to an embodiment of the present disclosure.

FIG. 2 is a block diagram illustrating an internal configuration of a computing device in an embodiment of the present disclosure.

FIG. 3 is a diagram showing an artificial intelligence (AI)-based learning skill and habit training system through question generation according to another embodiment of the present disclosure.

FIG. 4 is a diagram showing a supplementary learning terminal of FIG. 3.

FIG. 5 is a diagram showing a first learning attitude correction terminal of FIG. 3.

FIG. 6 is a diagram showing a holder frame of FIG. 5.

FIGS. 7 and 8 are diagrams showing a frame vibrator of FIG. 6.

FIG. 9 is a diagram showing a tapping unit of FIG. 8.

FIG. 10 is a flowchart illustrating an AI-based learning skill and habit training method through question generation according to an embodiment of the present disclosure.

FIG. 11 is a conceptual view of an exemplary user display using an AI-based learning skill and habit training system through question generation according to an embodiment of the present disclosure.

FIG. 12 is a flowchart of an AI-based learning skill and habit training method through question generation according to an embodiment of the present disclosure.

FIGS. 13, 14, 15, 16 and 17 are conceptual views showing an exemplary type of a question generated by an AI-based learning skill and habit training system through question generation according to an embodiment and a user input in response to the question.

FIG. 18 is a flowchart illustrating an AI-based learning skill and habit training method through question generation according to another embodiment of the present disclosure.

FIG. 19 is a flowchart showing an exemplary use of an AI-based learning skill and habit training method through question generation according to an embodiment of the present disclosure together with learning steps before, during and after class.

### DETAILED DESCRIPTION OF EXEMPLARY EMBODIMENTS

In describing the embodiments of the present disclosure, when it is determined that a certain detailed description of known elements or functions may obscure the subject matter of the embodiments of the present disclosure, the detailed description is omitted. In the drawings, elements that are irrelevant to the embodiments of the present disclosure are omitted, and like reference numerals are affixed to like elements.

In the embodiments of the present disclosure, when an element is referred to as being “connected to”, “coupled to” or “linked to” another element, it can be directly connected to the other element, and intervening elements may be present. Additionally, the term “comprises” or “includes” when used in this specification, specifies the presence of stated element but does not preclude the presence or addition of one or more other elements unless the context clearly indicates otherwise.

In the embodiments of the present disclosure, the terms “first”, “second” and the like are used to distinguish one element from another, and are not intended to limit the order or importance between the elements unless otherwise specified. Accordingly, in the scope of the embodiments of the present disclosure, a first element in an embodiment may be referred to as a second element in other embodiment, and likewise, a second element in an embodiment may be referred to as a first element in other embodiment.

In the embodiments of the present disclosure, the distinguishable elements are for the purpose of clearly describing the features of each element, and it does not necessarily mean that the elements are separated. That is, a plurality of elements may be integrated into a single hardware or software, and a single element may be distributed into a plurality of hardware or software. Accordingly, unless the context clearly indicates otherwise, the integrated or distributed embodiment is included in the scope of the embodiments of the present disclosure.

In the present disclosure, a network may be the concept including a wired network and a wireless network. In this instance, the network may refer to a communication network for data exchange between a device and a system and between devices, and is not limited to a specific network.

The embodiments described herein may have aspects of entirely hardware, partly hardware and partly software, or entirely software. The term “unit”, “device” or “system” as used herein refers to a computer related entity such as hardware, a combination of hardware and software, or software. For example, the unit, module, device or system as used herein may include a process that is being executed, a processor, an object, an executable, a thread of execution, a program, and/or a computer, but is not limited thereto. For example, both an application running on a computer and the computer may correspond to the unit, module, device or system of the present disclosure.

Additionally, the device as used herein may be not only a mobile device such as a smartphone, a tablet PC, a wearable device and a Head Mounted Display (HMD), but also a fixed device such as a PC or an electric appliance having a display function. Additionally, for example, the device may be a cluster in a car or an Internet of Things (IoT) device. That is, the device as used herein may refer to devices in which applications can work, and is not limited to a particular type. Hereinafter, for convenience of description, devices in which applications work are referred to as the device.

In the present disclosure, a communication method of the network is not particularly limited, and each element may not be connected by the same networking method. The network may include not only communication methods using communication networks (for example, a mobile communication network, a wired Internet, a wireless Internet, a broadcast network and a satellite network) but also local area wireless communication between devices. For example, the network may include any communication method for networking between objects, and is not limited to wired communication, wireless communication, 3G, 4G, 5G, or any other method. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VOIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) and communication using ultrasonic waves, but is not limited thereto.

The elements described in various embodiments are not necessarily essential elements, and some of them may be optional elements. Accordingly, embodiments including a subset of elements described in the embodiments are also included in the scope of the embodiments of the present disclosure. Additionally, embodiments including the elements described in various embodiments and further including other elements are included in the scope of embodiments of the present disclosure.

Hereinafter, the embodiments of the present disclosure will be described in detail with reference to the accompanying drawings.

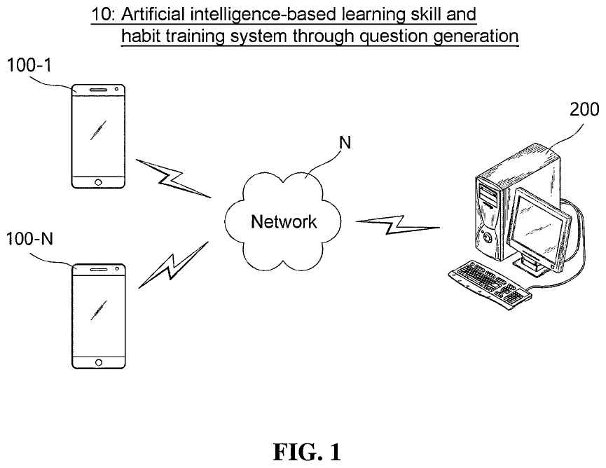

FIG. 1 is a diagram showing an example of an operating environment of a system according to an embodiment of the present disclosure. Referring to FIG. 1, at least one learner terminal 100-1 to 100-N and a training server 200 are connected via a network N. FIG. 1 is provided to describe the present disclosure by way of illustration and the number of user devices or servers is not limited to the exemplary number of FIG. 1.

The learner terminal 100 may be a fixed or mobile terminal implemented by a computer system. The learner terminal 100 may include, for example, a smart phone, a mobile phone, a navigation, a computer, a laptop computer, a terminal for digital broadcast, Personal Digital Assistant (PDA), Portable Multimedia Player (PMP), a tablet PC, a game console, a wearable device, an internet of things (IoT) device, a virtual reality (VR) device and an augmented reality (AR) device. For example, in the embodiments, the at least on learner terminal 100-1 to 100-N may, in substance, refer to one of various physical computer systems that can communicate with the training server 200 via the network N using a wireless or wired communication method.

The training server 200 may be implemented as a computer device or a plurality of computer devices that provide instructions, code, files, content and services by communication with the at least one learner terminal 100-1 to 100-N via the network N. For example, the training server 200 may be a system that provides each service to the learner terminal 100 having made connection via the network N. As a more specific example, the training server 200 may provide intended services (for example, providing information) to the learner terminal 100 through an application as a computer program installed and running on the learner terminal 100. As another example, the server may distribute files for installation and execution of the above-described application to the learner terminal 100, receive user input information and provide the corresponding services.

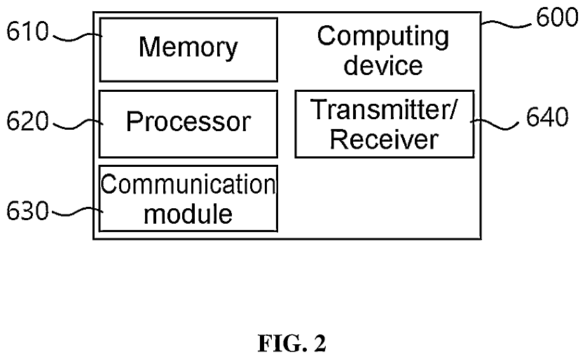

FIG. 2 is a block diagram illustrating an internal configuration of a computing device 600 in an embodiment of the present disclosure. The computing device 600 may be applied to the at least one learner terminal 100-1 to 100-N or the training server 200 described above with reference to FIG. 1, and the at least one learner terminal 100-1 to 100-N or the training server 200 may have the same or similar internal configuration with the addition or exception of some components.

Referring to FIG. 2, the computing device 600 may include a memory 610, a processor 620, a communication module 630 and a transmitter/receiver 640. The memory 610 is a non-transitory computer-readable recording medium, and may include a non-volatile mass storage device such as Random Access Memory (RAM), Read Only Memory (ROM), disk drive, solid state drive (SSD) and flash memory. Here, the non-volatile mass storage device such as ROM, SSD, flash memory and disk drive may be a permanent storage device that is different from the memory 610 and be included in the above-described device or server. Additionally, the memory 610 may store an operating system and at least one program code (for example, code for a browser installed and running on the learner terminal 100 or an application installed on the learner terminal 100 to provide a specific service). These software components may be loaded from other computer-readable recording medium than the memory 610. The other computer-readable recording medium may include computer-readable recording media such as floppy drive, disk, tape, DVD/CD-ROM drive and memory card.

In another embodiment, the software components may be loaded onto the memory 610 through the communication module 630 rather than the computer-readable recording medium. For example, the at least one program may be loaded onto the memory 610 based on the computer program (for example, the above-described application) installed by the files provided by developers or a file distribution system (for example, the above-described server) that distributes the installer files of the application via the network N.

The processor 620 may be configured to process the instructions of the computer program by performing the basic operations, i.e., arithmetic and logic operations and input and output operations. The instructions may be provided to the processor 620 by the memory 610 or the communication module 630. For example, the processor 620 may be configured to execute the received instructions according to the program code stored in the recording device such as the memory 610.

The communication module 630 may provide a function for communication between the at least one learner terminal 100-1 to 100-N and the training server 200 via the network N, and may provide a function for communication between each of the at least one learner terminal 100-1 to 100-N and/or the training server 200 and another electronic device.

The transmitter/receiver 640 may be a means for interfacing with an external input/output device (not shown). For example, the external input device may include a keyboard, a mouse, a microphone and a camera, and the external output device may include a display, a speaker and a haptic feedback device.

As another example, the transmitter/receiver 640 may be a mean for interfacing with a device having an integrated input and output function such as a touchscreen.

Additionally, in other embodiments, the computing device 600 may include a larger number of components than the components of FIG. 2 according to the nature of a device to which the computing device 600 is applied. For example, when the computing device 600 is applied to the learner terminal 100, the computing device 600 may include at least some of the above-described input/output devices or may further include other components such as a transceiver, a Global Positioning System (GPS) module, a camera, various types of sensors and a database. As a more specific example, when the user device is a smartphone, the computing device 600 may further include a variety of components generally included in the smartphone, for example, an acceleration sensor, a gyro sensor, a camera module, a variety of physical buttons, buttons using a touch panel, an input/output port and a vibrator for vibration.

The training server 200 according to an embodiment of the present disclosure may be implemented using the hardware components of the computing device 600 shown in FIG. 2. In this case, the training server 200 includes the memory 610 in which executable instructions are stored; the communication module 630 configured to communicate with the user device; and the processor 620 connected to the memory 610 and the communication module 630 to enable communication between them.

The processor 620 is configured to execute the instructions stored in the memory 610 to perform the AI-based learning skill and habit training method through question generation according to the below-mentioned embodiments of the present disclosure. For example, in an embodiment, the processor 620 is configured to execute the instructions stored in the memory 610, to perform the steps of: setting at least one question topic to be transmitted to the learner terminal 100-1 to 100-N that is the learner's personal terminal and a learning step of each question topic; receiving question information corresponding to a desired question topic from the learner on the learner terminal when the desired question topic is selected from the learner among the at least one question topic transmitted to the learner terminal 100-1 to 100-N through the learner terminal 100-1 to 100-N; generating a learning result through machine learning-based analysis of the question information received from the learner terminal 100-1 to 100-N; and transmitting the next learning content recommended for the learner based on the learning result obtained through the machine learning to the learner terminal 100-1 to 100-N.

However, the Ai-based learning skill and habit training method through question generation performed by the processor 620 is not limited to the above-described steps, and various embodiments of the training method will be described in detail below through the specification.

Referring to FIG. 1, the AI-based learning skill and habit training system 10 through question generation according to an embodiment of the present disclosure includes the learner terminal 100 and the training server 200.

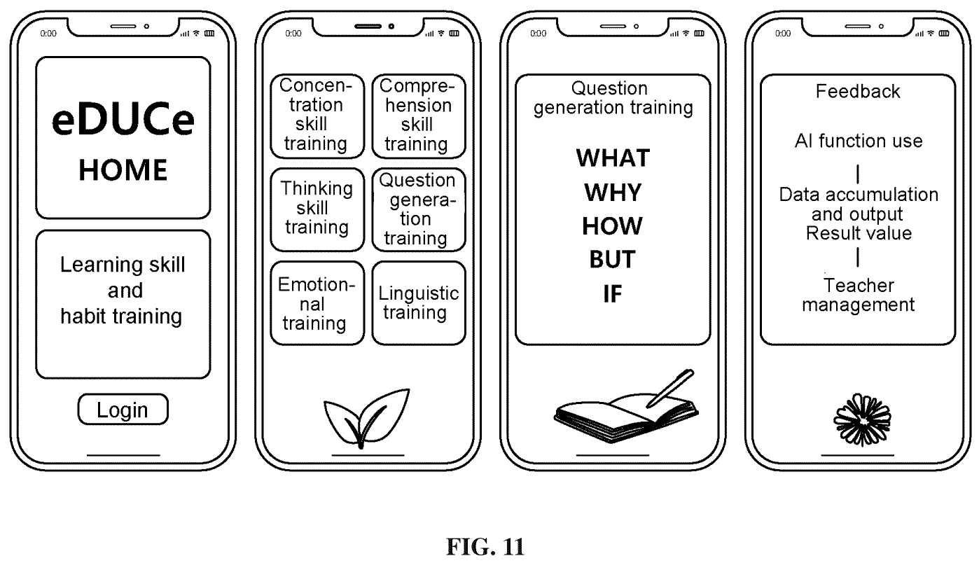

The learner terminal 100 is the learner's personal terminal, and a dedicated application for providing an AI-based learning skill and habit training service through question generation having UI shown in FIG. 11 is installed in the learner terminal 100. When the at least one question topic is received, the learner terminal 100 receives the learner's desired question topic selected from the learner, then receives the question information corresponding to the selected question topic from the learner and transmits it to the training server 200 via the network N.

The training server 200 provides the AI-based learning skill and habit training service through question generation, sets the at least one question topic to be transmitted to the learner terminal 100 and the learning step of each question topic, generates the learning result through machine learning-based analysis of the question information received from the learner terminal 100, and transmits the next learning content recommended for the learner to the learner terminal 100 based on the learning result obtained through the machine learning.

The AI-based learning skill and habit training system 10 through question generation according to an embodiment of the present disclosure as configured above may achieve cognitive learning training for developing learning skills by training the learners' concentration, memorization, understanding and thinking skills through the learning skill habit training program based on AI such as machine learning and big data.

Additionally, the AI-based learning skill and habit training system 10 through question generation according to an embodiment of the present disclosure as configured above performs the learning process before, during and after class by learning skill and habit training using textbooks as teaching materials, to help students to effectively study and make them interested in regular classes, thereby improving student achievement.

Additionally, the AI-based learning skill and habit training system 10 through question generation according to an embodiment of the present disclosure as configured above induces behavior modification through students' self-reflection by humanistic education in conjunction with emotional training (emotion reflection) and linguistic training (gratitude training), thereby improving the students' abilities to lead their lives.

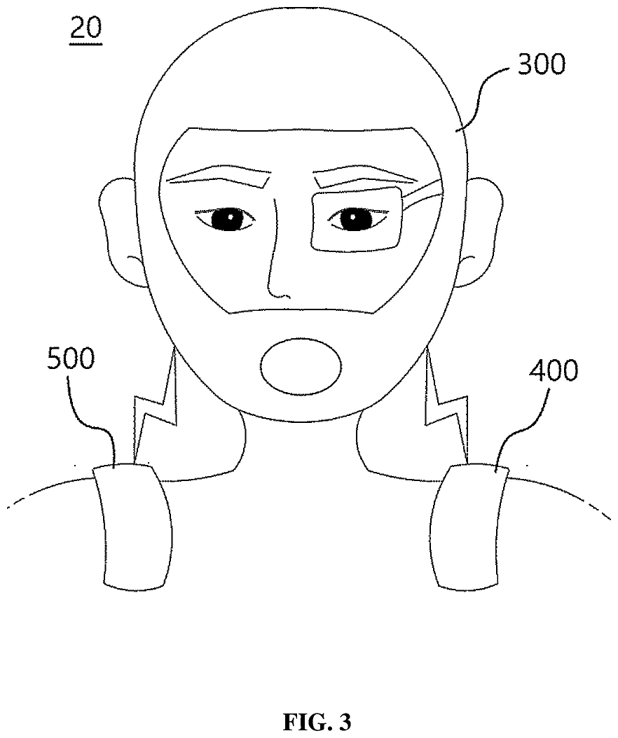

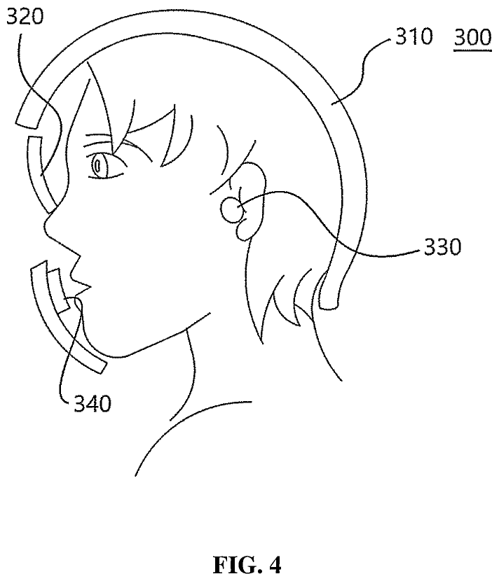

FIG. 3 is a diagram showing the AI-based learning skill and habit training system through question generation according to another embodiment of the present disclosure.

Referring to FIG. 3, the AI-based learning skill and habit training system 20 through question generation according to another embodiment of the present disclosure includes the learner terminal 100, the training server 200, a supplementary learning terminal 300, a first learning attitude correction terminal 400 and a second learning attitude correction terminal 500.

Here, the learner terminal 100 and the training server 200 have the same components as those of FIG. 1 and its description is omitted.

The supplementary learning terminal 300 is formed in the shape of a helmet that is worn on the learner's head, and connects to the learner terminal 100 to receive, from the learner terminal 100, the question topic transmitted from the training server 200 to the learner terminal 100 and output a sound or a letter, and receive the learner's voice and transmit it to the learner terminal 100.

In an embodiment, the supplementary learning terminal 300 may include a helmet body 310 worn on the learner's head, an organic light emitting diode (OLED) glass 320 of which a transparent OLED display window is made to output the question topic in symbols such as characters, a speaker 330 to output the question topic in an audio format, and a microphone 340 to receive the learner's voice.

The first learning attitude correction terminal 400 is mounted on the learner's left shoulder part S, and connects to the learner terminal 100 via the network N, to vibrate to teach the learner to sit in a good posture for learning when the learner is learning in a bad posture for learning (for example, learning in a lying or inclined posture) during question generation training.

The second learning attitude correction terminal 500 is mounted on the learner's right shoulder part S, and connects to the learner terminal 100 via the network N, to vibrate to teach the learner to sit in a good posture for learning when the learner is learning in a bad posture for learning during question generation training.

The AI-based learning skill and habit training system 20 through question generation according to another embodiment of the present disclosure as configured above may not only improve the learner's learning effect, but also correct the learner's learning posture, thereby significantly reducing the fatigue after learning for a long time through right posture.

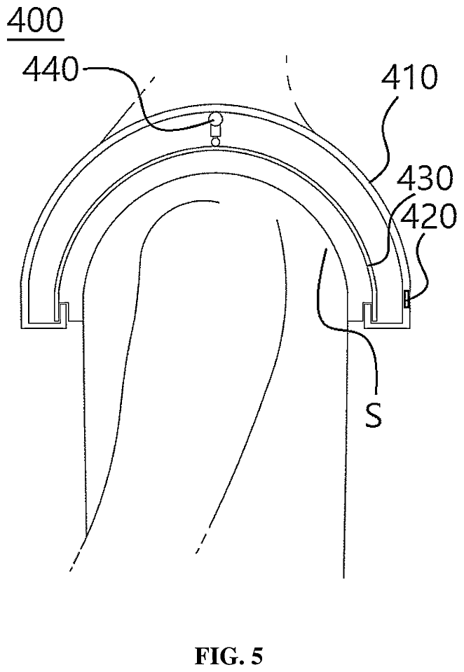

FIG. 5 is a diagram showing the first learning attitude correction terminal of FIG. 3.

Referring to FIG. 5, the first learning attitude correction terminal 400 includes a holder frame 410, a gyro sensor 420, a mounting frame 430, a frame vibrator 440 and a drive belt 450.

Here, the second learning attitude correction terminal 500 includes the same components as the first learning attitude correction terminal 400 as described below. The holder frame 410, the gyro sensor 420, the mounting frame 430, the frame vibrator 440 and the drive belt 450 of the first learning attitude correction terminal 400 may be equally applied, and to avoid redundancy, its description is omitted.

The holder frame 410 is curved in an arch shape to conform to the shape of the shoulder so that it can be placed on the learner's left shoulder part S, and the gyro sensor 420, the mounting frame 430, the frame vibrator 440 and the drive belt 450 are installed at the holder frame 410.

The gyro sensor 420 is installed at the holder frame 410 and measures a position change of the learner's left shoulder and transmits it to the learner terminal 100.

The mounting frame 430 is curved in an arch shape to conform to the shape of the shoulder so that the mounting frame 430 can be tightly mounted on the learner's left shoulder and is installed on the inner side of the holder frame 410 facing the shoulder.

The frame vibrator 440 slidably moves on a curve along the inner side of the holder frame 410 under the control of the learner terminal 100, and after stopping the sliding movement at a specific location, rotates to tap the mounting frame 430, to provide vibration for warning to the learner.

The drive belt 450 is installed along the inner side of the holder frame 410 and engaged with the frame vibrator 440, and slidably moves the frame vibrator 440 on the curve along the inner side of the holder frame 410 by the forward or backward rotation under the control of the learner terminal 100.

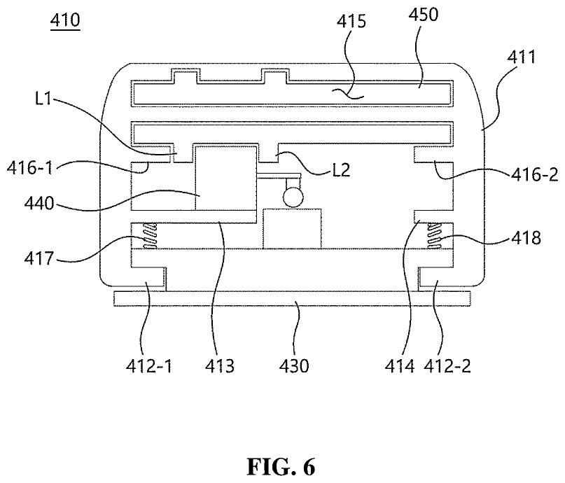

In an embodiment, as shown in FIG. 6, the drive belt 450 may have two protrusions L1, L2 spaced apart from each other by a distance corresponding to the left-right width of the frame vibrator 440 to prevent separation of the frame vibrator 440.

In an embodiment, the learner terminal 100 may analyze the learner's current posture in real time using sensing values received from each gyro sensor installed at the first learning attitude correction terminal 400 and the second learning attitude correction terminal 500, and when the learner's posture is determined to be bad, generate vibration at the wrong position to call the learner's attention.

The first learning attitude correction terminal 400 as configured above may correct the learner's learning posture, thereby significantly reducing the fatigue after learning for a long time through right posture.

FIG. 6 is a diagram showing the holder frame of FIG. 5.

Referring to FIG. 6, the holder frame 410 includes an arch-shaped frame 411, two frame holder steps 412-1, 412-2, a gear mounting step 413, a spring support step 414, a belt mounting space 415, two belt support steps 416-1, 416-2, a first support spring 417 and a second support spring 418.

The arch-shaped frame 411 is curved in an arch shape to conform to the shape of the shoulder so that it may be mounted on the learner's left shoulder part S, and has an open internal space to form an open portion on the lower side facing the shoulder, and the two frame holder steps 412-1, 412-2, the gear mounting step 413, the spring support step 414, the belt mounting space 415, the two belt support steps 416-1, 416-2, the first support spring 417 and the second support spring 418 are installed at the arch-shaped frame 411.

The two frame holder steps 412-1, 412-2 are bent in the horizontal direction such that one side and the other side of the lower part of the arch-shaped frame 411 face each other to fasten one side and the other side of the mounting frame 430.

The gear mounting step 413 is formed along one side wall of the internal space of the arch-shaped frame 411 so that the frame vibrator 440 is mounted and allowed to move while rotating, and forms gear teeth along the upper side so that the frame vibrator 440 is installed and connected and engaged with the gear teeth.

The spring support step 414 is disposed opposite the gear mounting step 413 and protrudes along the other side wall of the internal space of the arch-shaped frame 411.

The belt mounting space 415 is extended in the front-rear direction along the inner side of the arch-shaped frame 411, facing the internal space of the arch-shaped frame 411, spaced apart in an upward direction from the internal space of the arch-shaped frame 411, so that the upper side of the drive belt 450 is mounted and allowed to move.

The two belt support steps 416-1, 416-2 protrude in the horizontal direction such that they face each other from the top of one side wall and the other side wall of the internal space of the arch-shaped frame 411 to support one side and the other side of the lower side of the drive belt 450 mounted on the upper surface of the internal space of the arch-shaped frame 411.

The first support spring 417 includes a plurality of first support springs arranged at a regular interval along the lower side of the gear mounting step 413 to bring one side of the upper part of the mounting frame 430 mounted on the frame holder step 412 formed on one side into close contact in the downward direction.

The second support spring 418 includes a plurality of second support springs arranged at a regular interval along the lower side of the spring support step 414 to bring the other side of the upper part of the mounting frame 430 mounted on the frame holder step 412 formed on the other side into close contact in the downward direction.

The holder frame 410 as configured above may stably fasten the mounting frame 430, and allow the frame vibrator 440 to make a precise sliding movement.

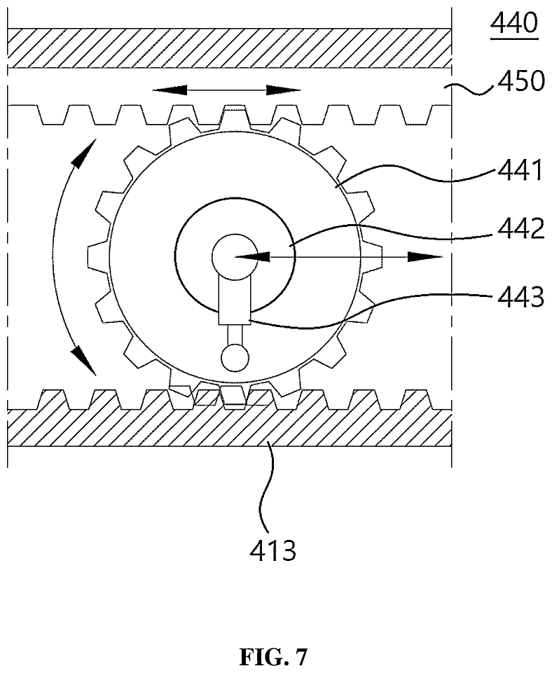

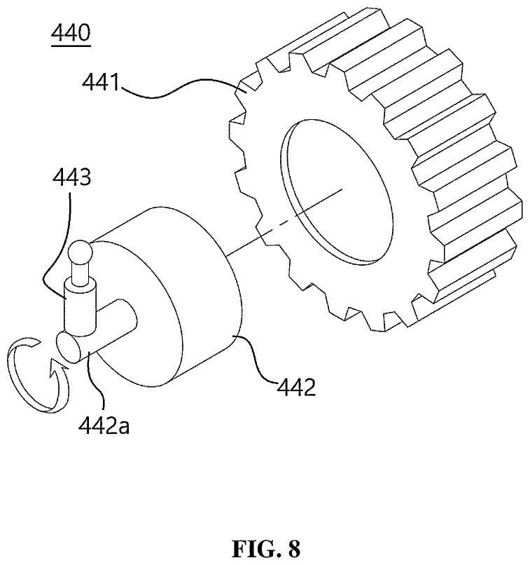

FIGS. 7 and 8 are diagrams showing the frame vibrator of FIG. 6.

Referring to FIGS. 7 and 8, the frame vibrator 440 includes a sliding gear 441, a rotary motor 442 and a tapping unit 443.

The sliding gear 441 has the upper side installed and connected and engaged with gear teeth formed along the outer surface of the lower side of the drive belt 450 and the lower side installed and connected and engaged with gear teeth formed along the upper side of the gear mounting step 413. The sliding gear 441 rotates with the forward or backward rotation of the drive belt 450 and moves back and forth while rotating along the upper side of the gear mounting step 413, and the rotary motor 442 is installed at the sliding gear 441.

The rotary motor 442 is installed at the inner side of the sliding gear 441, and its rotation is controlled by the learner terminal 100.

The tapping unit 443 is installed at a drive axis 442a of the rotary motor 442 exposed from the sliding gear 441 perpendicularly to a rotation axis of the sliding gear 441, and taps the mounting frame 430 while rotating with the rotation of the drive axis 442a of the rotary motor 442.

The frame vibrator 440 as configured above may make a precise movement on the curve by the drive belt 450, and enable effective vibration generation of the mounting frame 430.

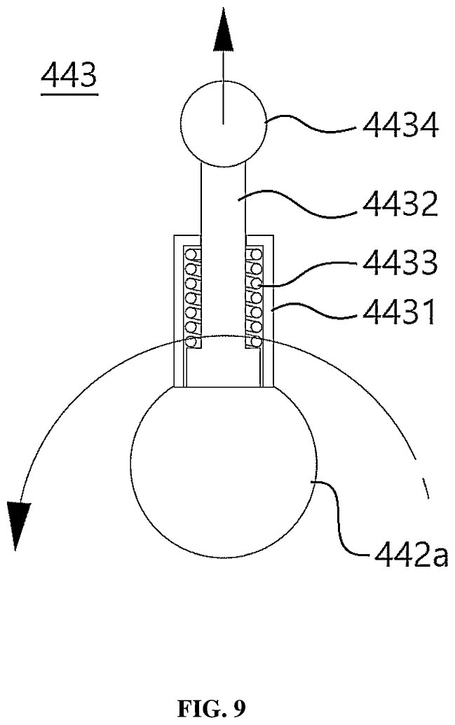

FIG. 9 is a diagram showing the tapping unit of FIG. 8.

Referring to FIG. 9, the tapping unit 443 includes a housing 4431, a vertical movement frame 4432, a frame support spring 4433 and a tapping rubber ball 4434.

The housing 4431 is installed at the drive axis 442a of the rotary motor 442 perpendicularly to the rotation axis of the sliding gear 441, and the vertical movement frame 4432 and the frame support spring 4433 are installed at the internal space of the housing 4431.

The vertical movement frame 4432 is mounted in the internal space of the housing 4431, and the upper side is exposed to the upper side of the housing 4431.

The frame support spring 4433 is installed in the internal space of the housing 4431, the vertical movement frame 4432 is disposed along the inner side, and the lower side is mounted on a step formed along the lower side of the vertical movement frame 4432 to bring the vertical movement frame 4432 into close contact with the lower side of the housing 4431.

The tapping rubber ball 4434 is installed at the upper side of the vertical movement frame 4432 exposed to the upper side of the housing 4431 and taps the mounting frame 430.

The tapping unit 443 as configured above does not disrupt the rotation of the sliding gear 441 because the total length does not contact the upper side of the mounting frame 430 before the operation of the rotary motor 442 as shown in FIG. 6, but as the drive axis 442a of the rotary motor 442 rotates, the vertical movement frame 4432 is gradually exposed from the housing 4431, the tapping rubber ball 4434 contacts the upper side of the mounting frame 430 and the tapping rubber ball 4434 taps the mounting frame 430 to generate vibration to the mounting frame 430.

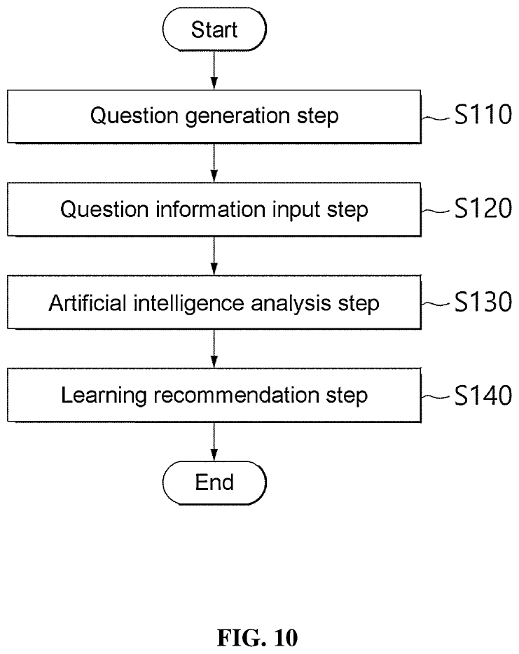

FIG. 10 is a flowchart illustrating an AI-based learning skill and habit training method through question generation an embodiment of the present disclosure.

Referring to FIG. 10, the AI-based learning skill and habit training method through question generation according to an embodiment of the present disclosure starts with setting, by the training server 200 for providing the AI-based learning skill and habit training service through question generation, at least one question topic to be transmitted to the learner terminal 100 that is the learner's personal terminal and the learning step of each question topic (S110).

When the learner's desired question topic is selected from the at least one question topic transmitted from the training server 200 to the learner terminal 100 through the learner terminal 100, the learner terminal 100 receives question information corresponding to the selected question topic from the learner and transmits it to the training server 200 (S120).

In an embodiment, in the question information input step (S120), the question information corresponding to any one type of “when an answer is clearly found in the text”, “when an answer is absent in the text but can be found through immediate thinking” and “when an answer is absent in the text but can be found by inference through deep thinking and experience” may be received from the learner.

In an embodiment, in the question information input step (S120), the learner is instructed to select and input the learning step related to the question topic among the learning steps “before class”, “during class”, and “after class”, and the learner may be allowed to change the type of the question topic that the learner has to input for each step “before class”, “during class”, and “after class”.

For example, the UI of the dedicated application installed on the learner terminal 100 may be configured to complete the input of the corresponding question topic only after the input of the question of type (1) in the pre-class step of the specific topic, the question of type (2) in the in-class step, and the question of type (3) in the post-class step.

The training server 200 generates the learning result through machine learning-based analysis of the question information received from the learner terminal 100 (S130).

In an embodiment, in the AI analysis step (S130), at least one information of “number of input questions”, “time taken to input the question”, “size of question information (i.e., length of the question)”, and “multidimensional information including features of words included in the question” may be extracted as input data from data of the question information received from the learner terminal 100, and the question information may be classified using the extracted input data as an input value of a machine learning-based analysis model.

In an embodiment, the “features of words included in the question” may refer to a result of classifying the words in the question into words about specific and basic representation (ex., time, place, weather, name, etc.) or words about abstract and advanced interpretation (ex., intention, implication, emotion, speculation, etc.).

In an embodiment, in the AI analysis step (S130), for word feature analysis, the type of the word may be classified by converting the question information to vector data by word embedding that represents a word having similar meaning as a similar vector value by using distributed representation from the learner's input question information, and the learning result may be generated based on the result of classifying the question information.

That is, the learning result is used to determine the next learning content depending on whether the number of questions inputted by the learner is plentiful, whether the question was inputted in a short time, and how advanced the question is.

In an embodiment, the AI analysis step (S130) may include applying the appropriate analysis model for each question information inputted by the learner in multidimensional information for machine learning analysis to classify the learning result according to each learner's level.

For example, the learning result may be classified for each learner's level by separately training each of the analysis model for learners who input one question and the analysis model for learners who input two questions.

The training server 200 transmits the next learning content recommended for the learner based on the learning result obtained through the machine learning to the learner terminal 100 (S140).

In an embodiment, the “next learning content” may be a question topic that comes next in association with the question topic in the previous class (i.e., the question that has been generated and inputted), or a question topic determined to need more question generation training among each step (i.e., before class, during class, and after class) of the question topic in the previous class.

In an embodiment, in the learning recommendation step (S140), a teacher, parent or manager's feedback may be received as to whether the learner's input question information is right for the required type of question in the corresponding learning process ([(1) when an answer is clearly found in the text, (2) when an answer is absent in the text but can be found through immediate thinking, and (3) when an answer is absent in the text but can be found by inference through deep thinking and experience]), and when the feedback saying that the question is not a right question for the type is received at a predetermined ratio or more, the next learning content may be recommended after leveling down the learning step (after class->during class, during class->before class) of the question topic or the step (topic II->topic I) of each topic in the recommended learning content through the machine learning by the AI analysis step.

For example, in an embodiment, the level refers to a sequence of each topic in a plurality of topics set for learning according to a preset order, and leveling down the topic as used herein may refer to reverting the learning topic back to a predetermined prior topic from the current topic. Alternatively, in another embodiment, the level refers to a sequence of learning steps in each topic performed in the order of [before class], [during class], and [after class], and leveling down the learning step as used herein may refer to reverting the learning step back to a predetermined prior step from the current learning step.

The AI-based learning skill and habit training method through question generation having the above-described steps according to an embodiment of the present disclosure may achieve cognitive learning training for developing learning skills by training the learners' concentration, memorization, understanding and thinking skills through the learning skill and habit training program based on AI such as machine learning and big data.

Additionally, the AI-based learning skill and habit training method through question generation having the above-described steps according to an embodiment of the present disclosure performs the learning process before, during and after class by learning skill and habit training using textbooks as teaching materials, to help students to effectively study and make them interested in regular classes, thereby improving student achievement.

Additionally, the AI-based learning skill and habit training method through question generation having the above-described steps according to an embodiment of the present disclosure may induce behavior modification through students' self-reflection by humanistic education in conjunction with emotional training (emotion reflection) and linguistic training (gratitude training), thereby improving the students' abilities to lead their lives.

Hereinafter, some exemplary embodiments of the present disclosure will be described in detail.

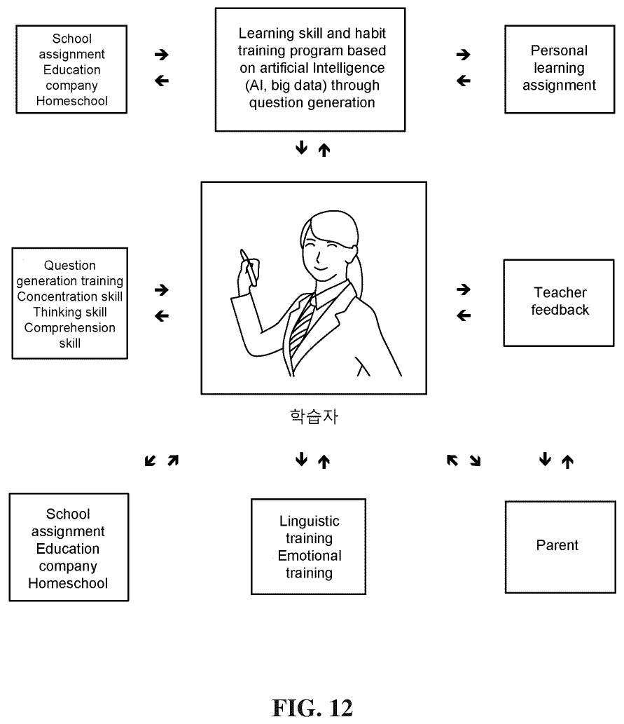

FIG. 11 is a conceptual view of an exemplary user display using the AI-based learning skill and habit training system 10 through question generation according to an embodiment, and FIG. 12 is a flowchart of the AI-based learning skill and habit training method through question generation according to an embodiment.

Referring to FIGS. 11 and 12, the AI-based learning skill and habit training system 10 through question generation according to the embodiments acts as a server to which the user can connect by using a mobile device such as a smartphone, a personal computer, a laptop computer and a tablet computer. The user may connect to the AI-based learning skill and habit training system 10 through question generation by using the computing device, and select question generation training to use the AI-based learning skill and habit training system 10 through question generation according to this embodiment.

The AI-based learning skill and habit training method through question generation according to the embodiments may carry out question generation training in such a way that the user (for example, a student) does training corresponding to a school assignment or a personal learning assignment and receives the teacher and/or parent's feedback through the AI-based learning skill and habit training system 10 through question generation.

In the system 10 and method for learning skill and habit training based on AI through question generation according to the embodiments, the question generation step (S110) may correspond to the basic learning step. That is, the learning skill and habit training system and method through question generation may be configured to generate a right question for each of the learning steps (i) before class, (ii) during class and (iii) after class.

In the system 10 and method for learning skill and habit training based on AI through question generation according to the embodiments, the learning skill and habit to train through question generation is, for example, as follows.

### <Habit of Asking Question/Bravery of Asking Question/Method of Asking Question>

First, the habit of asking question is a method of checking the question itself by each item before, during and after class and may build the initial habit. This may be performed for habit training.

Second, the bravery of asking question is a method for overcoming vague fear coming from the habit training process, and may provide repeated experiences of bravery of asking various questions in a series of processes before, during and after class. The question during class may build confidence by training the questioning method and step rather than the content and level of the question.

Third, in the system 10 and method for learning skill and habit training based on AI through question generation according to the embodiments, the method of asking question may be performed by the following five steps.

The first step is [What-concept and relationship (knowledge)] step, and uses a question that understands the accurate concept in a convergent sense, and an exemplary question type includes “what is it?”, “what does it mean?”, “what does it say?”, “what is a difference in meaning?”.

The second step is a [Why-reason, cause (comprehension)] step and uses a question that asks reason and cause, and an exemplary question type includes “why do (does)˜?”, “what is the reason?”, “what is its cause?”.

The third step is a [How-process, inference (application)] step and uses a question about the detailed process, and is a process of bringing to a conclusion through logical inference. An exemplary question type includes “how did it go?”, “what will happen next?”.

The fourth step is a [But-refutation, criticism (analysis)] step and uses a high level of question in critical thinking to raise a counter argument. An exemplary question type includes “however why˜?”, “but how come˜?”.

The fifth step is a [If-supposition, imagination (synthesis)] step and uses a question variously stretched to hypothetical situations based on open thinking toward divergence beyond convergence. An exemplary question type includes “if˜, how will˜?”, “if˜, would it˜?”.

The learner (a student, etc.) using the system 10 and method for learning skill and habit training based on AI through question generation according to the embodiments is trained to develop the ability to create many questions, so it is important to create many questions. Additionally, the AI-based learning skill and habit training system 10 through question generation may be configured to perform the critical and creative training process through discussion when the learner gets used to question generation training.

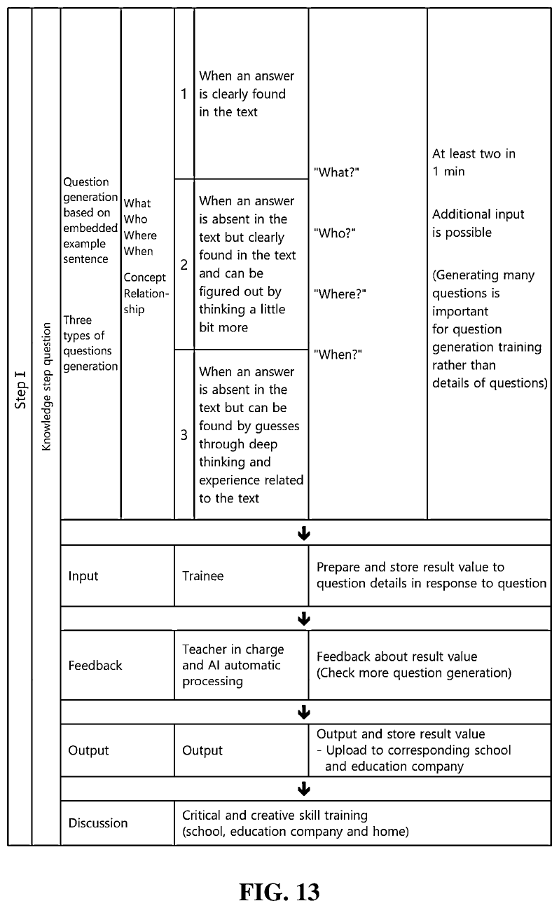

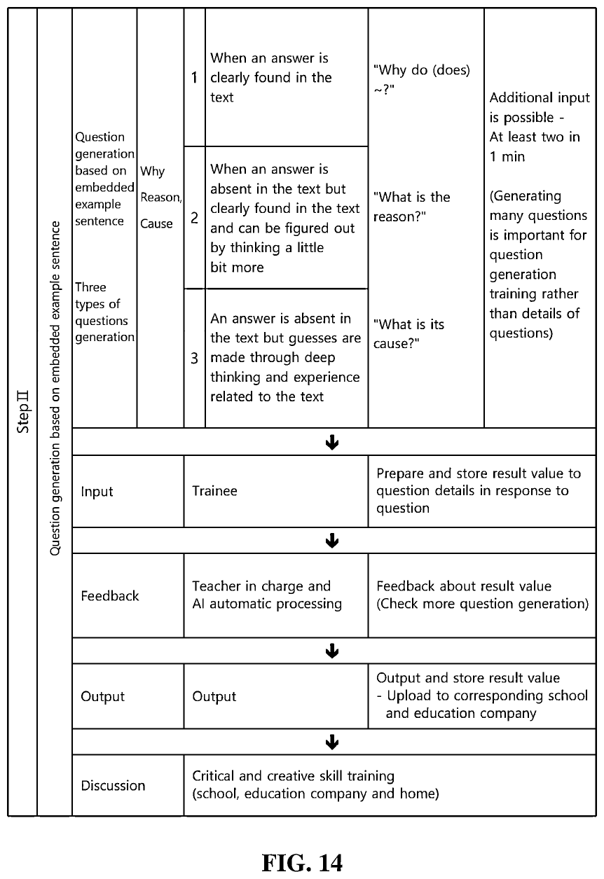

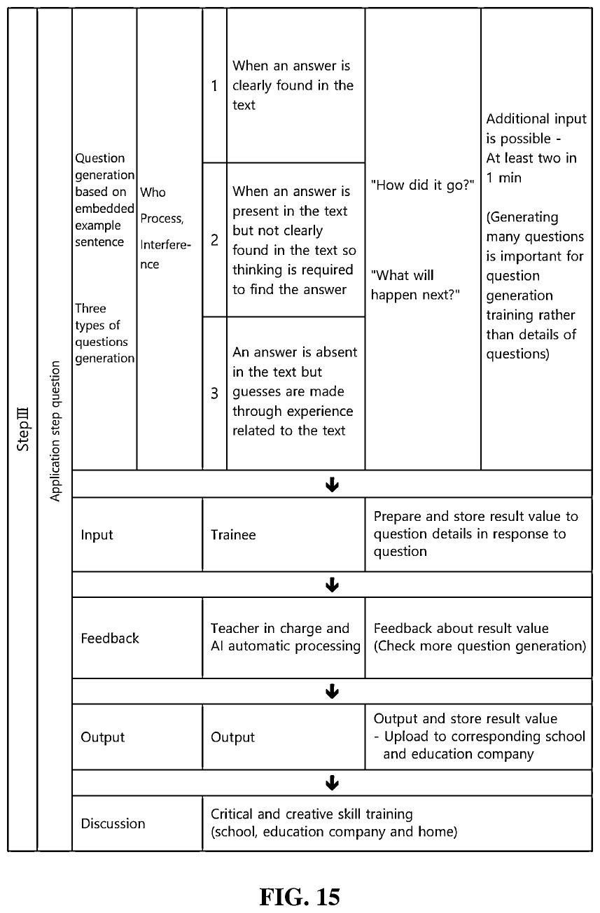

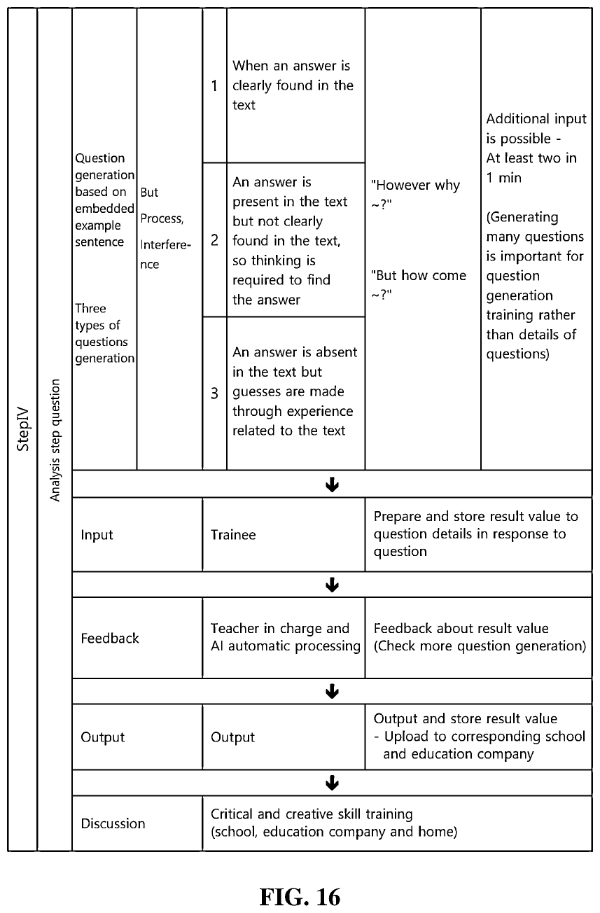

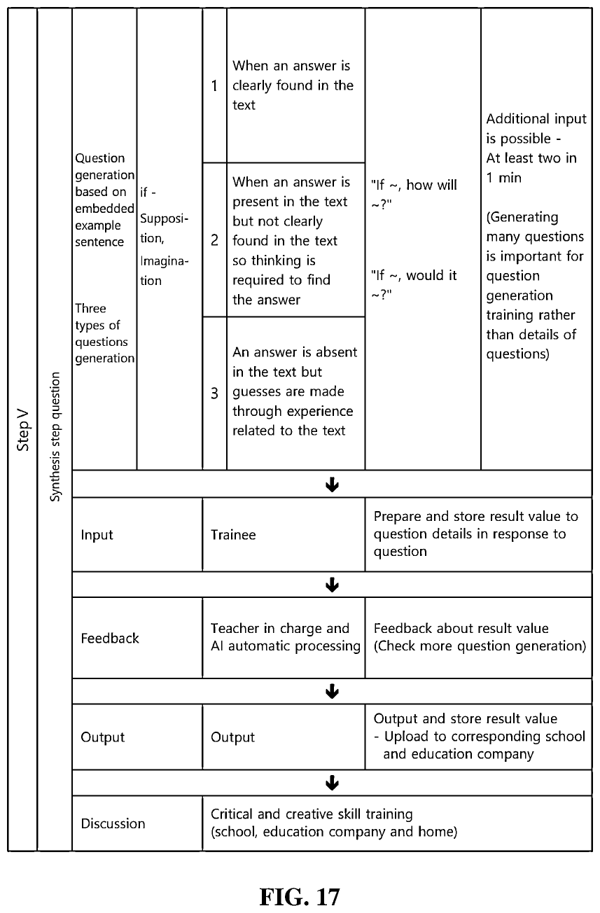

FIGS. 13 to 17 are conceptual views showing an exemplary type of question generated by the AI-based learning skill and habit training system through question generation according to an embodiment and its user input, FIG. 13 shows the first step question, FIG. 14 shows the second step question, FIG. 15 shows the third step question, FIG. 16 shows the fourth step question, and FIG. 17 shows the fifth step question.

The user using the AI-based learning skill and habit training system 10 through question generation according to the embodiments connects to the AI-based learning skill and habit training system 10 through question generation by using his/her computing device, selects the topic embedded in the AI-based learning skill and habit training system 10 through question generation, and generates and inputs a predetermined number (for example, 1 to 3) of questions for each preset step according to the topic.

In an embodiment, training may be configured to instruct users using the AI-based learning skill and habit training system 10 through question generation to input a particular number (for example, 2) of questions or more for a particular time (for example, 1 min). Additionally, training may be configured to instruct some learners to additionally input a prescribed number of questions or more. In the question generation training process by the AI-based learning skill and habit training method through question generation according to the embodiments, it is important to generate many questions rather than good questions.

The question generated by the learner through the AI-based learning skill and habit training system 10 through question generation may be outputted and/or stored as a result value. Additionally, the result value generated by the AI-based learning skill and habit training system 10 through question generation may be provided to the manager such as the teacher and/or parent corresponding to the learner. Furthermore, the AI-based learning skill and habit training system 10 through question generation may analyze users' learning results through the AI-based algorithm such as machine learning and big data.

In an embodiment, the learning result generated by the AI-based learning skill and habit training system 10 through question generation may be uploaded onto an external server at a school or an education company corresponding to the learner. In this instance, the learning result may include input data from the learner to the AI-based learning skill and habit training system 10 through question generation and/or an analysis result of the input data through the AI-based algorithm. For example, critical and creative training may be carried out using the learning result generated by the AI-based learning skill and habit training system 10 through question generation in the education field such as the school or education company.

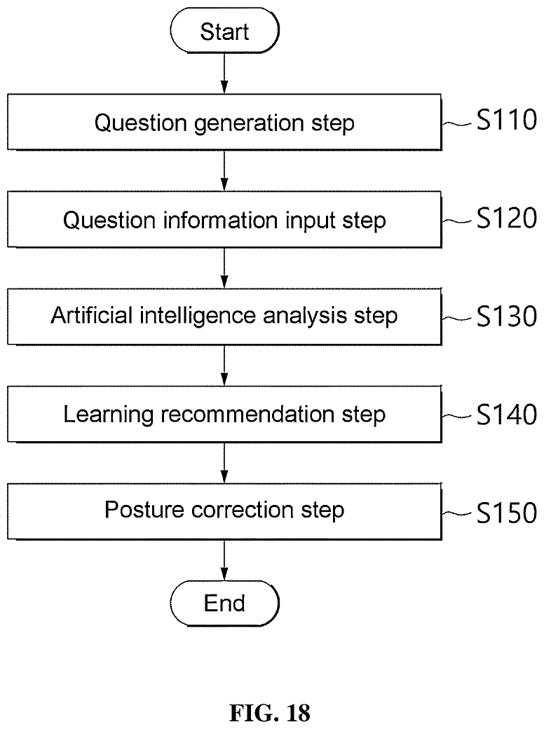

FIG. 18 is a flowchart illustrating the AI-based learning skill and habit training method through question generation according to another embodiment of the present disclosure.

Referring to FIG. 18, in the AI-based learning skill and habit training method through question generation according to another embodiment of the present disclosure, when the learner is learning in a bad posture for learning during question generation training using the first learning attitude correction terminal 400 mounted on the learner's left shoulder part and the second learning attitude correction terminal 500 mounted on the learner's right shoulder part as shown in FIG. 3, the first learning attitude correction terminal 400 and the second learning attitude correction terminal 500 vibrate at the same time or at different times to teach the learner to sit in a good posture for learning (S150).

The AI-based learning skill and habit training method through question generation having the above-described steps according to another embodiment of the present disclosure may not only improve the learner's learning effect, but also correct the learner's learning posture, thereby significantly reducing the fatigue after learning for a long time through right posture.

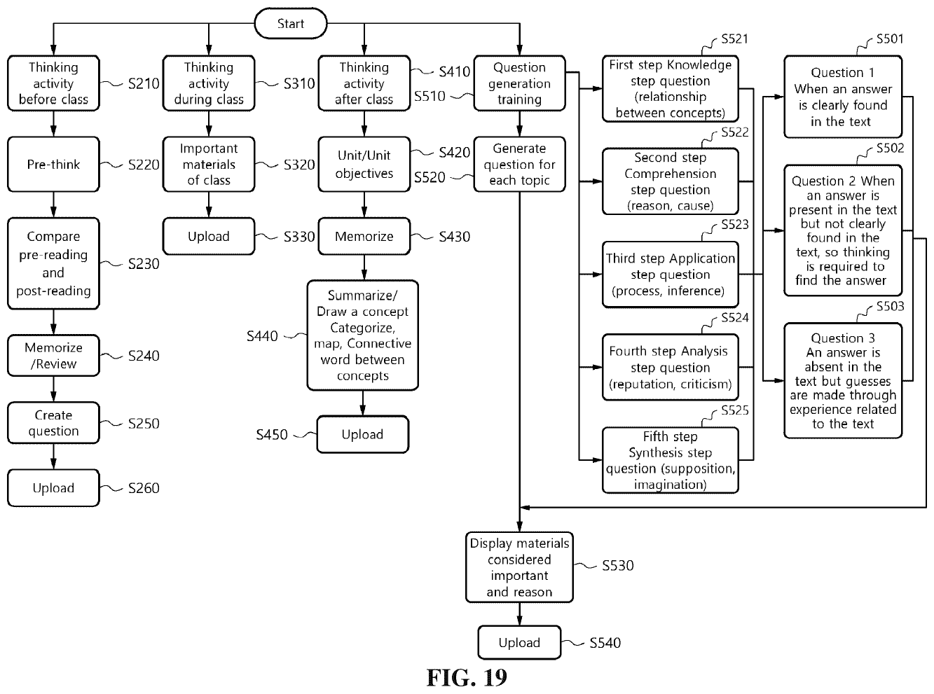

FIG. 19 is a flowchart showing an exemplary use of the AI-based learning skill and habit training method through question generation according to an embodiment of the present disclosure together with the learning steps before, during and after class.

Referring to FIG. 19, the AI-based learning skill and habit training method through question generation according to the embodiments may include the learning step before class (S210), the learning step during class (S310) and the learning step after class (S410) together with the step in the education program (S510), and the learning steps may be performed in a naturally connected manner according to the order of question generation before, during and after class. The learners may learn through a web or app-based program.

Under the assumption of the text-based class, in the learning step before class (S210), learners may perform the pre-learning process of seeing the title of the text or thinking about what the text is about before reading the text (S220), and comparing sameness and difference between the first thing that comes to mind and thoughts after reading the text (S230). Additionally, learners may perform the memorization and/or review process of thinking about the heading (subheading) of the text or illustration in the text (S240), and generate the corresponding question (S250). For example, learners may underline two or more materials that they do not know and generate the corresponding question.

Additionally, in the learning step during class (S310), learners may input important materials during class onto the system (S320).

Additionally, in the learning step after class (S410), learners may check the topic related to the class, for example, unit and unit objectives (S420), perform the memorization process of recalling memorable words or materials in the class materials (S430), and summarize the main points of the class, draw a concept map corresponding to the class, categorize the learning content, and/or set connective words between concepts (S440).

Finally, with regard to materials that learners did not understand, important materials, and materials that learners are consciously doubtful, learners may generate questions through the AI-based learning skill and habit training through question generation according to the embodiments (S530). As described above, in an embodiment, the question generation through the AI-based learning skill and habit training system through question generation may be performed by the first step (S521) of [What-concept and relationship (knowledge)], the second step (S522) of [Why-reason, cause (comprehension)], the third step (S523) of [How-process, inference (application)], the fourth step (S524) of [But-refutation, criticism (analysis)] and the fifth step (S525) of [If-supposition, imagination (synthesis)].

In an embodiment, the question information may correspond to any one type of “when an answer is clearly found in the text” (501), “when an answer is absent in the text but can be found through immediate thinking” (502) and “when an answer is absent in the text but can be found by inference through deep thinking and experience” (503). Additionally, in an embodiment, in addition with the question information, the learner may further input review information, for example, what the learner thinks is important and its reason (S530).

The learner's input content in the above-described steps may be uploaded onto the system (S260, S330, S450, S540), and the learner may receive the teacher's feedback to his/her uploaded content. Additionally, the AI-based learning skill and habit training system through question generation according to the embodiments may be further configured to output the learner's input content for the class such as learners' discussion and/or its feedback content.

The embodiments described hereinabove may be implemented, at least in part, in a computer program and recorded on a computer-readable recording medium. The computer-readable recording medium in which the program for embodying the embodiments is recorded includes any type of recording device in which computer-readable data is stored. Examples of the computer-readable recording medium include ROM, RAM, CD-ROM, magnetic tape, and an optical data storage device. Additionally, the computer-readable recording medium is distributed over computer systems connected via a network, and may store and execute a computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments shown in the drawings, this is provided for illustration purposes only and it will be appreciated by those having ordinary skill in the art that a variety of modifications and variations may be made thereto. However, it should be noted that such modifications fall within the technical protection scope of the present disclosure. Therefore, it should be noted that the true technical protection scope of the present disclosure includes other implementations, other embodiments and the appended claims and their equivalents by the technical spirit of the appended claims.

1. An artificial intelligence (AI)-based learning skill and habit training system through question generation, the system comprising:
a learner terminal that is a personal terminal that a learner uses, in which a dedicated application for providing an AI-based learning skill and habit training service through question generation is installed, the learner terminal configured to receive a desired question topic selected from the learner among at least one preset question topic, and receive question information corresponding to the selected question topic from the learner; and
a training server configured to provide the AI-based learning skill and habit training service through question generation, set the at least one question topic to be transmitted to the learner terminal and a learning step of each question topic, generate a learning result through machine learning-based analysis of the received question information from the learner terminal, and transmit a next learning content recommended for the learner to the learner terminal based on the learning result obtained through the machine learning.

2. A training server for providing an AI-based learning skill and habit training service through question generation, the training server comprising:
a memory in which executable instructions are stored; a communication module configured to communicate with a server; and a processor connected to the memory and the communication module to enable communication between them,
wherein the processor is configured to execute the instructions to perform the steps of:
setting at least one question topic to be transmitted to a learner terminal that is a personal terminal of a learner and a learning step of each question topic;
receiving question information corresponding to a desired question topic selected from the learner on the learner terminal from the learner in response to the question topic being selected from the learner through the learner terminal among the at least one question topic transmitted to the learner terminal;
generating a learning result through machine learning-based analysis of the received question information from the learner terminal; and
transmitting a next learning content recommended for the learner to the learner terminal based on the learning result obtained through the machine learning.

3. An AI-based learning skill and habit training method through question generation, the method comprising:
a question generation step of setting, by a training server for providing an AI-based learning skill and habit training service through question generation, at least one question topic to be transmitted to a learner terminal that is a personal terminal of a learner and a learning step of each question topic;
a question information input step of receiving question information corresponding to a desired question topic selected from the learner on the learner terminal from the learner and transmitting it to the training server, in response to the question topic being selected from the learner through the learner terminal among the at least one question topic transmitted from the training server to the learner terminal;
an AI analysis step of generating, by the training server, a learning result through machine learning-based analysis of the question information received from the learner terminal; and
a learning recommendation step of transmitting, by the training server, a next learning content recommended for the learner to the learner terminal based on the learning result obtained through the machine learning.

4. The AI-based learning skill and habit training method through question generation according to claim 3,
wherein the question information input step comprises receiving the question information corresponding to any one type of “when an answer is clearly found in a text”, “when an answer is absent in the text but can be found through immediate thinking” and “when an answer is absent in the text but can be found by inference through deep thinking and experience” from the learner.

5. The AI-based learning skill and habit training method through question generation according to claim 3,
wherein the question information input step comprises instructing the learner to select and input the learning step related to the question topic among the learning steps of “before class”, “during class”, and “after class” when the learner selects the corresponding question topic, and the learner is allowed to change a type of the question topic to be inputted by the learner for each step of “before class”, “during class”, and “after class”.

6. The AI-based learning skill and habit training method through question generation according to claim 3,
wherein the AI analysis step comprises extracting at least one information of “number of input questions”, “time taken to input the question”, “a size of the question information (i.e., a length of the question)”, and “multidimensional information including features of words included in the question” as input data from data of the question information received from the learner terminal, and classifying the question information using the extracted input data as input value of a machine learning-based analysis model,
wherein the “features of the words included in the question” refers to a result of classifying the words in the question into words about specific and basic representation or words about abstract and advanced interpretation, and
wherein the AI analysis step comprises:
for word feature analysis, converting the question information to vector data by word embedding that represents a word having similar meaning as a similar vector value by using distributed representation from the question information inputted by the learner to classify the type of the word, and generating the learning result based on a result of classifying the question information, and
applying an appropriate analysis model for each question information inputted by the learner in the multidimensional information for the machine learning analysis to classify the learning result according to a level of each learner.

7. The AI-based learning skill and habit training method through question generation according to claim 3,
wherein the next learning content is a question topic that comes next in association with the question topic in the next class (i.e., the question that has been generated and inputted), or a question topic determined to need more question generation training among each step (i.e., before class, during class, and after class) of the question topic in the previous class, and
wherein the learning recommendation step comprises receiving feedback from a teacher, parent or manager as to whether the question information inputted by the learner is right for the required type of question in the corresponding learning step, and recommending the next learning content by leveling down the question topic in learning content recommended through machine learning by the AI analysis step or the learning step in each topic, in response to the feedback saying that the question is not a right question for the type being received at a predetermined ratio or more.

8. The AI-based learning skill and habit training method through question generation according to claim 3, further comprising a posture correction step of teaching the learner in a bad posture for learning during question generation training to sit in a good posture for learning by vibration of a first learning attitude correction terminal and a second learning attitude correction terminal at a same time or at different times by using the first learning attitude correction terminal mounted on a left shoulder part of the learner and the second learning attitude correction terminal mounted on a right shoulder part of the learner.

9. A computer program stored in a computer-readable recording medium to perform the AI-based learning skill and habit training method through question generation according to claim 3 in combination with hardware.
